(19) United States
(12) Patent Application Publication
(10) Pub. No.: US 2019/0315420 A1
(43) Pub. Date: Oct. 17, 2019

(54) COLLAPSIBLE TIRE TREAD COVER

(71) Applicant: Mitchell David Chesney, Hermosa Beach, CA (US)

(72) Inventor: Mitchell David Chesney, Hermosa Beach, CA (US)

(21) Appl. No.: 16/453,922

(22) Filed: Jun. 26, 2019

Related U.S. Application Data
(63) Continuation of application No. 15/600,047, filed on May 19, 2017.
(60) Provisional application No. 62/339,385, filed on May 20, 2016.

(51) Int. Cl. B62H 3/08; B60C 7/24; B60C 99/00; B60C 5/02

(52) U.S. Cl. CPC B62H 3/08; B60C 7/24; B60C 5/04; B60C 5/025; B60C 99/00

(57) ABSTRACT

A tire tread cover for use with a vehicle wheel having a rim, a hub, and an opening between the rim and the hub. In one embodiment, the tire tread cover includes a flexible body and an attachment portion that extends from the body portion. The flexible body has a shape configured to cover a portion of a tire tread. The attachment portion is configured to (a) insert into the opening of the wheel and (b) engage the rim within the opening to hold the flexible body against the portion of the tire tread.

### CROSS-REFERENCE TO RELATED APPLICATION(S)

This application is a continuation of U.S. patent application Ser. No. 15/600,047, entitled “COLLAPSIBLE TIRE TREAD COVER,” filed May 19, 2017, which claims priority to U.S. Patent Application No. 62/339,385, entitled “COLLAPSIBLE TIRE TREAD COVER,” filed May 20, 2016, the contents of which are hereby incorporated by reference in their entireties.

### TECHNICAL FIELD

The following disclosure relates generally to wheel covers for vehicles, and more particularly, to a collapsible tire tread cover for a bicycle and/or other types of open-rimmed wheels.

### BACKGROUND

Lightweight transportable vehicles, such as bicycles, collect dust, dirt, and other debris during use. Some users store their bicycles in their home and/or their office. Before bringing a bicycle into such areas, a user may need to clean the bicycle's tires to keep the dust, dirt, and debris from being tracked into the user's home, office, or other areas. Alternately, a user may place a rug under the bicycle's tires, cover each of the tires with a bag, or place the bicycle on a stand to keep the tires from dirtying and contaminating surfaces, such as carpeted surfaces. One challenge with traditional stowage systems is that they can be bulky and awkward for users to transport with their bicycle. Another challenge is that traditional stowage devices, such as tire sheaths or socks, can be difficult to install because they are installed over the entire bike wheel and/or they require the wheel to be removed from the bicycle.

### BRIEF DESCRIPTION OF THE DRAWINGS

FIG. 1A is a side view and FIG. 1B is an enlarged side view illustrating a portion of a bicycle wheel and a collapsible tread cover engaged with the wheel in accordance with an embodiment of the present technology.

FIG. 2A is front view and FIG. 2B is an isometric view showing the tread cover removed from the wheel.

FIG. 3 is a top view showing the tread cover of FIGS. 2A and 2B in an uncollapsed state.

FIG. 4A is an isometric view of the tread cover in the uncollapsed state, and FIGS. 4B-4D are various side views of the tread cover in a collapsed state and engaged with the bicycle.

FIGS. 5A and 5B are isometric views that show a collapsible tread cover in expanded and collapsed states, respectively, in accordance with another embodiment of the present technology.

### DETAILED DESCRIPTION

The following disclosure describes various embodiments of a collapsible tire tread cover for use with a bicycle or other types of vehicle wheels. As described below, the tread cover is configured to fit over a relatively small portion of a tire tread and an adjacent portion of a wheel rim. The tread cover does not extend around the entire circumference of the wheel, but may only cover the portion of the tread that is proximate to a floor surface and/or other surfaces (e.g., a wall surface) upon which the wheel is placed. In one aspect of the technology, the tread cover can keep such surfaces free of dust, dirt, debris, and other contaminants that may fall off of the tire tread, others portions of the wheel (e.g., the rim), and/or portions of the vehicle frame while stowing the vehicle. The tread cover can also protect surfaces (e.g., hardwood, plastic, drywall, surfaces) from marring and/or physical damage, such as scratches and the like.

In another aspect of the technology, the tread cover has a compact size. As such, the tread cover can be conveniently carried in a user's backpack, pant pocket, or other area on the user's person when not in use. In a related aspect, the tread cover's compact size makes it easier to install than conventional wheel covers that tend to be bulky and require the user to wrap the cover around the entire wheel, which can be difficult and awkward when the wheel is relatively large, and especially so when the wheel is still attached to the vehicle frame.

In general, the disclosed tread cover can be installed on one or more wheels of generally lightweight vehicles, such as non-motorized vehicles. In various embodiments described below and shown in the Figures, the tread cover is described in the context of a bicycle wheel. In other embodiments, however, the tread cover can be implemented with other types of wheels, such as stroller wheels, carriage wheels, wheels of non-passenger vehicles (e.g., casters, dolly wheels, etc.), and the like. In some embodiments, the tread cover can be used on the wheel(s) of a moped, motorcycle, or other motorized vehicle.

Many of the details and features shown in the Figures are merely illustrative of particular embodiments of the technology. Accordingly, other embodiments can have other details and features without departing from the spirit and scope of the present technology. In addition, those of ordinary skill in the art will understand that further embodiments can be practiced without several of the details described below. Furthermore, various embodiments of the technology can include structures other than those illustrated in the Figures and are expressly not limited to the structures shown in the Figures. Moreover, various elements and features illustrated in the Figures may not be shown to scale.

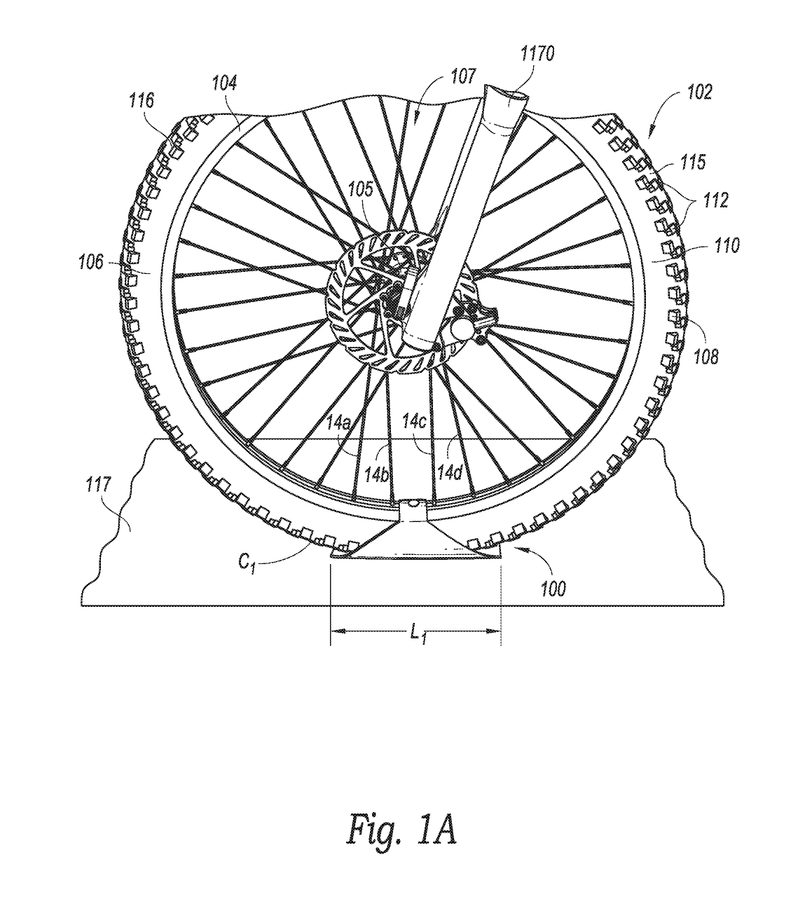

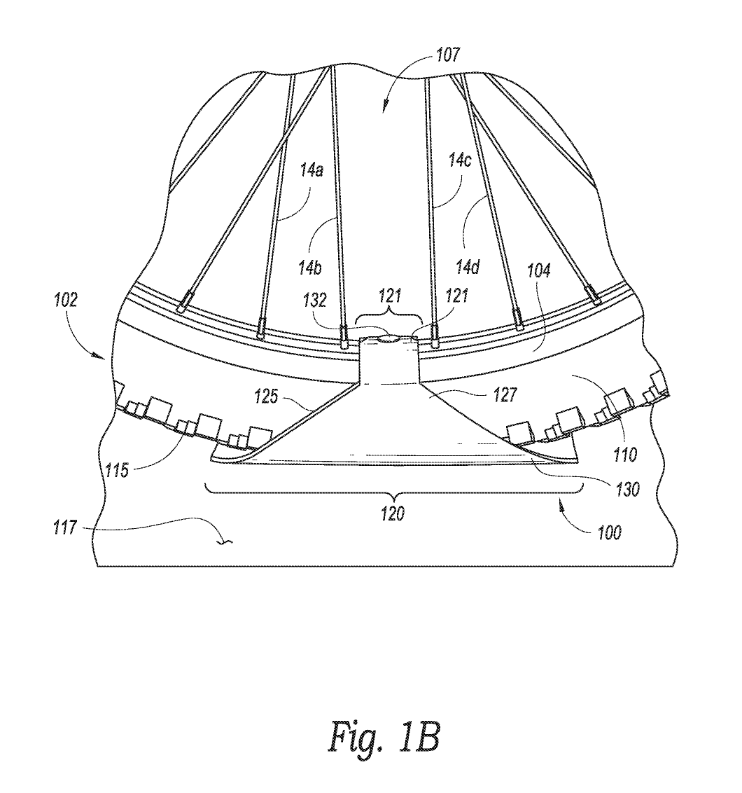

FIG. 1A is a side view and FIG. 1B is an enlarged side view illustrating a portion of a tire tread cover 100 (“tread cover 100”) in a collapsed or closed state and attached to a wheel 102 (“wheel 102”) of bicycle 170 in accordance with an embodiment of the present technology. Referring to FIG. 1A, the wheel 102 includes a rim 104, a tire 106 carried by the rim 104, and a hub 105 coupled to the rim 104 by a plurality of support members, or spokes 14 (identified individually as first through fourth spokes 14a-d, respectively). The wheel 102 can be referred to as having an “open-rim” structure. In particular, the wheel 102 has an opening 107 between the hub 105 and the rim 104. In various embodiments, an open-rimmed wheel can include metal spokes or similar wires, bars, etc., that connect a wheel rim to a central hub of the wheel. In other embodiments, an open rim structure may include a plate (e.g., a cast, fiberglass, or thick-plastic plate) with radially spaced openings, metal or plastic spars, or other features that form one or more openings between the wheel rim and the hub.

The tire 106 includes an outer tread region 108 (“tread 108”) and a sidewall 110 located on each side of the tread 108. The tread 108 can include an exterior surface 115 (“tread surface 115”) and raised grip features 112, such as knobs separated by grooves, that are formed in the tread surface 115. In some embodiments, the tread 108 can be a “slick” tread that does not include knobs or grooves.

The tread cover 100 is attached to the wheel 102 at generally the 6 o'clock position along an outer circumference C₁ of the tire 106. The tread cover 100 wraps around a section of the tire 106 and a section of the wheel rim 104 to cover a region of the wheel 102 that is proximate to a surface 117 (e.g., a carpeted surface) onto which the wheel 102 has been placed. In the illustrated embodiment, the tread cover 100 spans a length L₁ generally between the first spoke 14a and the fourth spoke 14d. The length L₁ is substantially less than the length of the outer circumference C₁ of the tire 106. In some embodiments, the length L₁ of the tread cover 100 can be different (e.g., larger or smaller) than the length shown in the illustrated embodiment. In various embodiments, the ratio of the length L₁ of the tread cover 100 to the length of the outer circumference C₁ can be less than or equal to, e.g., ¼, ⅛, 1/10, 1/16, or 1/30.

Referring to FIG. 1B, the tread cover 100 includes a flexible body 120 (e.g., a flexible jacket) having a base region 130 and at least one flap region 127 (“first flap 127”) adjacent the base region 130. The base region 130 extends generally laterally between the floor surface 117 and the tread surface 115. The first flap 127 has at least one edge 125 (“first edge 125”) and at least one attachment portion 121 (“first attachment portion 121”) projecting from the first edge 125. The first flap 127 is configured to fold over the tire sidewall 110 of the tread 108.

The first attachment portion 121 inserts into the opening 107 of the wheel 102 between the second and third spokes 14b and 14c. An attachment feature or fastener 132 couples the first attachment portion 121 with another portion of the flexible body 120 (not visible in FIG. 1B). In the illustrated embodiment, the other portion of the flexible body is an opposing flap region (not visible in FIG. 1B).

The fastener 132 can include, for example, a snap (e.g., a button snap), a clip, clasp, buckle, magnet(s), hook and loop (e.g., Velcro®), or the like. In the closed configuration shown in FIG. 1B, the first attachment portion 121 engages a portion of the wheel rim 104 to snugly hold the flexible body 120 of the tread cover 100 against the tire 106. The base region 130 can have a shape that at least partially conforms to the tread surface 115, and the flap 127 can have a shape that at least partially conforms to the shape of the tire sidewall 110. The flap 127 can also at least partially conform to the shape of the rim 104 and/or a portion of the tread surface 115.

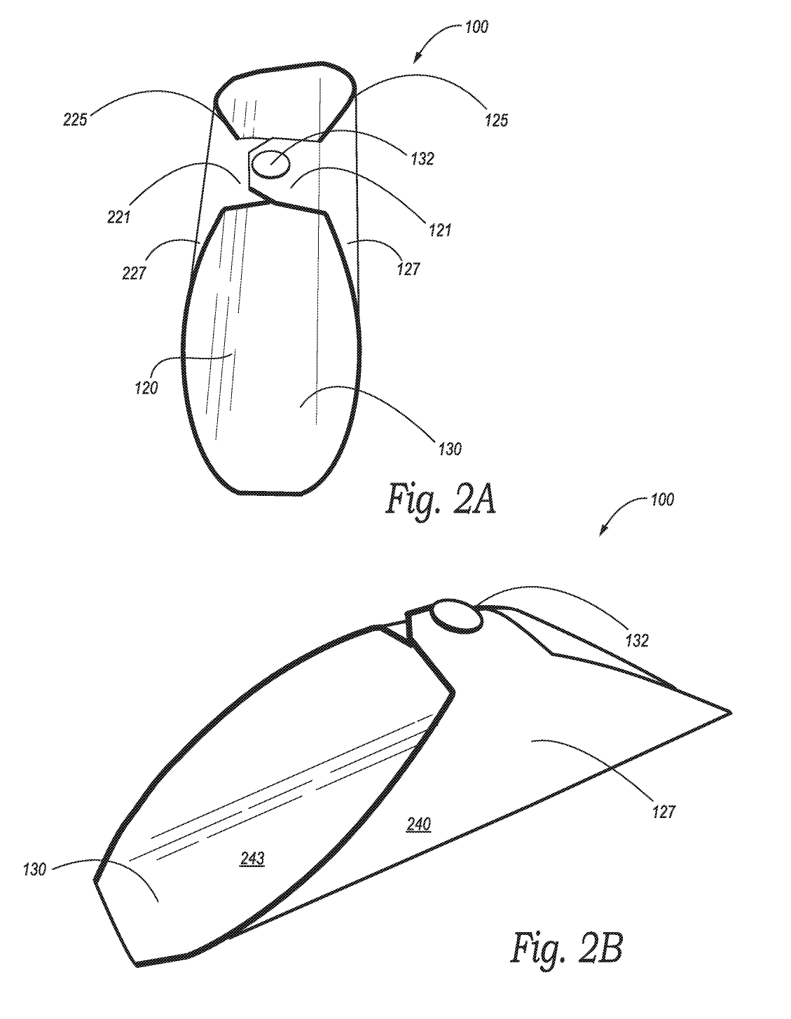

FIG. 2A is front view, and FIG. 2B is an isometric view showing the tread cover 100 removed from the wheel 102 (FIG. 1A) and in the closed state. Referring to FIGS. 2A and 2B together, the fastener 132 releasably couples the first attachment portion 121 to a second attachment portion 221 of the tread cover 100. The second attachment portion 221 can be similar to the first attachment portion 121, but projects from a second edge 225 of flexible body 120. In the illustrated embodiment, the first attachment portion 121 is an extension of the first flap 127, and the second attachment portion 221 is an extension of a second flap region 227 (“second flap 227”). The second flap 227 can cover an opposing sidewall of the tread 108 (FIG. 1A) in a manner similar to that of the first flap 127, as discussed above.

Referring to FIG. 2B, the tread cover 100 can include an outer surface 240 that contacts the floor surface 117 (FIG. 1A), and an inner surface 243 that contacts the tread surface 115 (FIG. 1A). In some embodiments, one or both of the outer and inner surfaces 240 and 243 can be textured and/or treated. For example, in one embodiment the outer surface 240 can be smoother than the inner surface 243. In one aspect of this embodiment, a smooth outer surface 240 can allow the bicycle 170 (FIG. 1A) to slide on certain surfaces (e.g., hardwood, concrete, etc.). Such sliding can allow the bicycle 170 to be moved without rotating the wheel 102 and without having to pick up the bicycle and reorient the tread cover 100 due to rotation of the wheel 102. Alternately, the outer surface 240 can be rubberized or otherwise configured to prevent sliding.

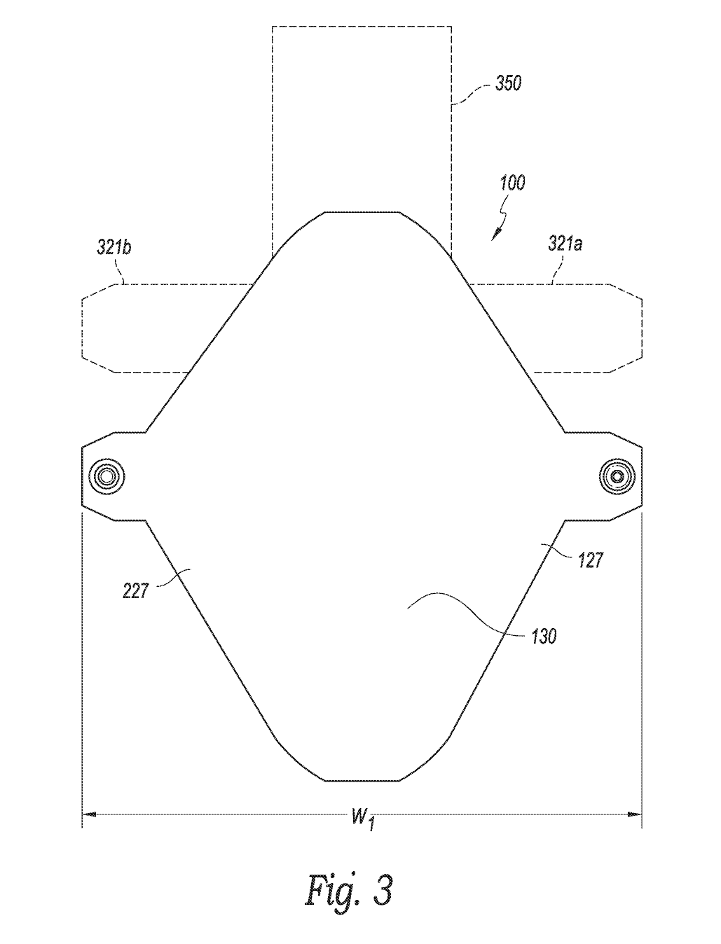

FIG. 3 is a top view showing the tread cover 100 in an uncollapsed or open state. In various embodiments, the flexible body can 120 have a width W₁ sized such that the tread cover 100 forms a snug fit around the tire 106 (FIG. 1A) and the wheel rim 104 (FIG. 1A). The tread cover 100 can be formed from a thin sheet of material, such as leather, cloth, plastic, rubber, synthetic rubber, ductile metal (e.g., aluminum), and/or other suitable flexible materials. Although in the illustrated embodiment the base region 130 is formed from a single material that is integral with the flaps 127, 227, in other embodiments, the base region 130 and the flaps 127, 227 can be non-integral and/or the tread cover 100 can be formed from multiple materials of different type. For example, in one embodiment the base region 130 can be made from leather, while the flaps 127, 227 can be made from cloth that is sewn to the leather base.

The tread cover 100 can have any of a variety of shapes for covering the tread 108 (FIG. 1A), securing the tread cover 100 to the wheel 102 (FIG. 1A), and protecting the floor surface 117 (FIG. 1A). In the illustrated embodiment, the base region 130 of the tread cover 100 has a rectangular shape, and the flaps 127, 227 have a generally triangular shape. In other embodiments, the tread cover 100 can have other shapes (e.g., ovular, circular, rectilinear shapes) that are configured to protect the floor surface 117 and/or other surfaces and prevent the spread of debris and contaminants. For example, the base region 130 can include an elongated section 350 (shown in hidden lines) for collecting additional dirt and debris that falls off of the tire 106 (FIG. 1A). In some embodiments, the tread cover 100 can include additional attachment portions 321a and 321b (shown in hidden lines) and corresponding fastener(s) (not shown) to further secure the tread cover 100 to the wheel 102. The additional attachment portions 321 can extend, for example, between the first and second spokes 14a and 14b or other spokes shown in FIG. 1A.

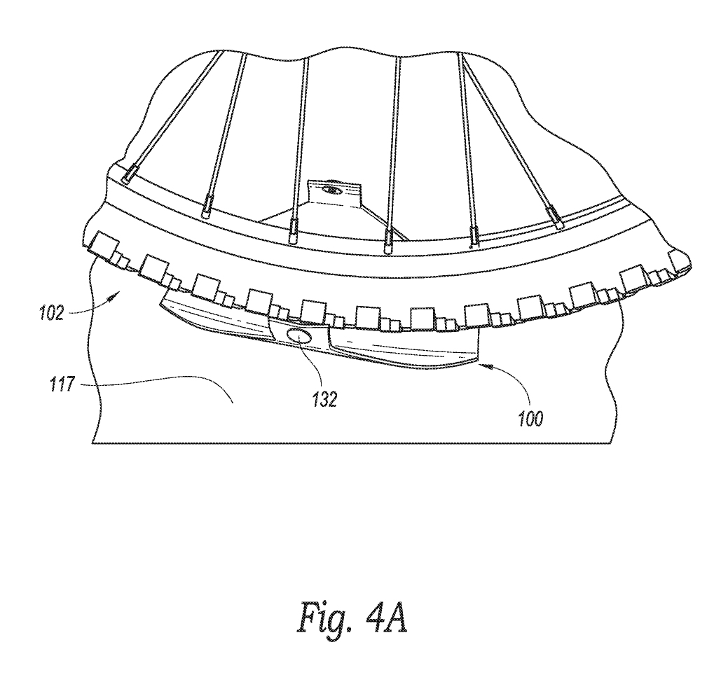

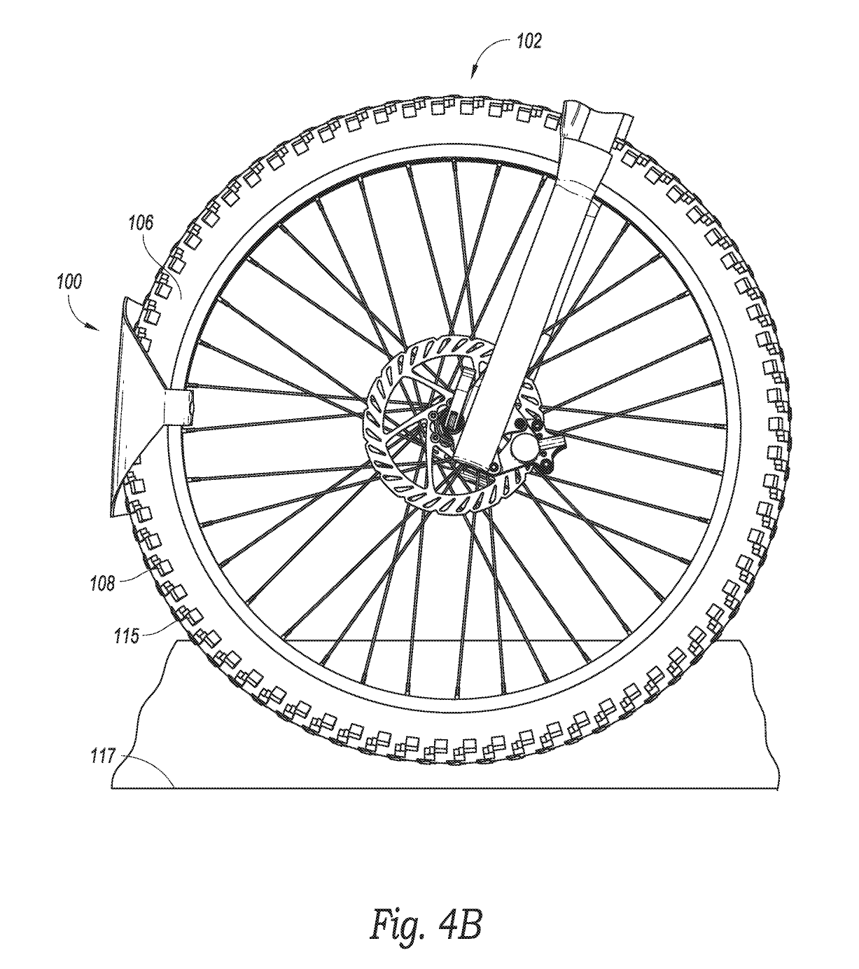

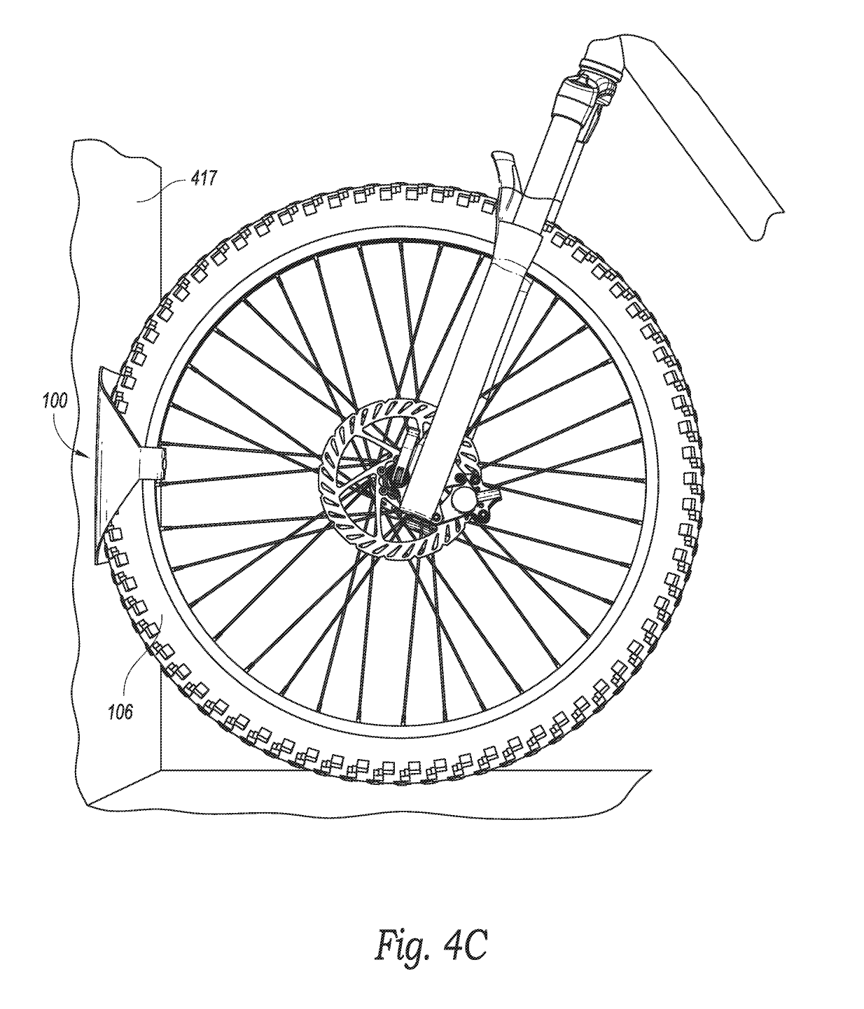

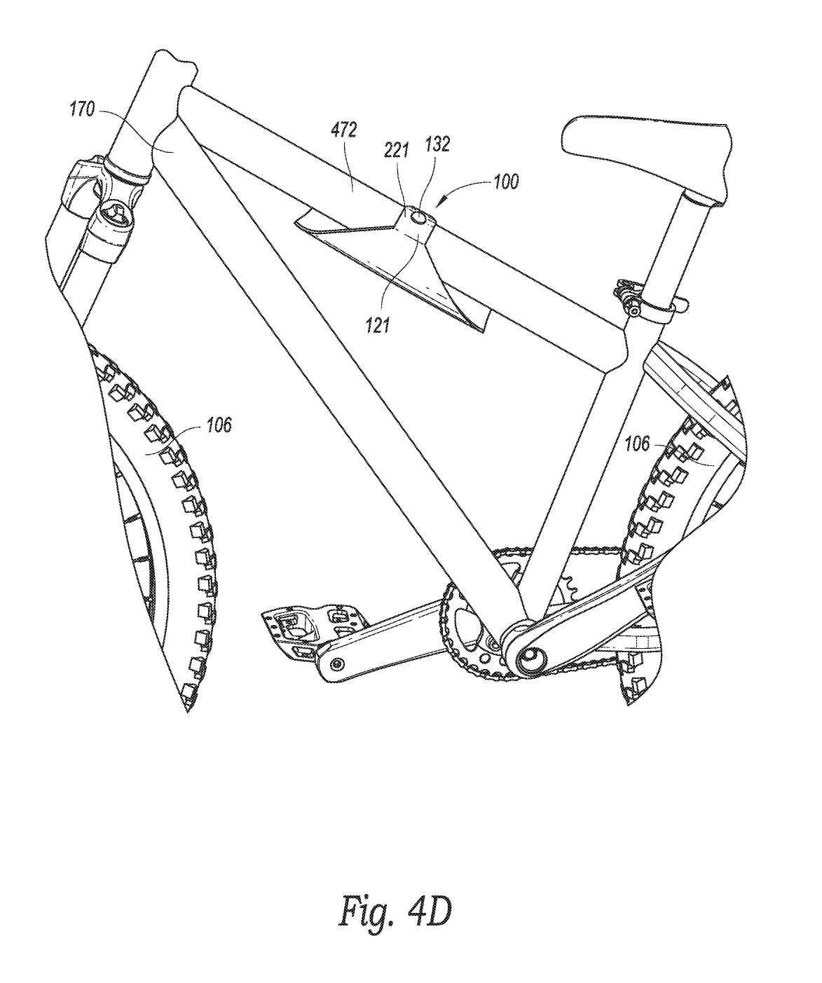

FIG. 4A is an isometric view of the tread cover 100 in an expanded or open state and detached from the wheel 102, FIGS. 4B and 4C are side views showing the tread cover 100 in the closed state and re-attached to the wheel 102, and FIG. 4D is a side view showing the tread cover 100 in the closed state and attached to a frame of the bicycle 170. Referring to FIG. 4A, the tread cover 100 can be opened by releasing the fastener 132 (e.g., unsnapping the fastener) so that the tread cover 100 expands or unfolds from the closed state to the open state. Once opened, the tread cover 100 can be pulled out from under the wheel 102 and/or the wheel 102 can be rotated in the forward or backward direction so that the user can retrieve the tread cover 100 from the floor surface 117.

Referring to FIG. 4B, the tread cover 100 can be re-attached to the wheel 102 by folding it over the tire 106 at, e.g., the 9 o'clock position, and rotating the wheel 102 in a clockwise or counter-clockwise direction until the tread cover 100 is located, again, between the floor surface 117 and the tread surface 115. In one aspect of the technology, the tread cover 100 can be installed on the tire 106 without having to remove the wheel 102 from the bicycle 170. In a related aspect, the tread cover 100 can be positioned between a vertical surface 417 (e.g., a wall surface) and the tire 106 when the tread cover 100 is at the 9 o'clock position, as shown in FIG. 4C, or other positions.

Referring to FIG. 4D, the tread cover 100 can be attached, for example, to an upper tube 472 of the bicycle 170 while the tread cover 100 is not in use. The tread cover 100 can be attached to the upper tube 472 by folding it around the tube and coupling the attachment portions 121, 221 via the fastener 132 in a manner similar to engaging the tread cover 100 with one of the bike tires 106, as discussed above. The tread cover 100 can alternately be attached to other portions of the bicycle 170, such as a lower tube, a seat tube, or the handlebars. Alternately, a user can carry the tread cover on his person, as discussed above.

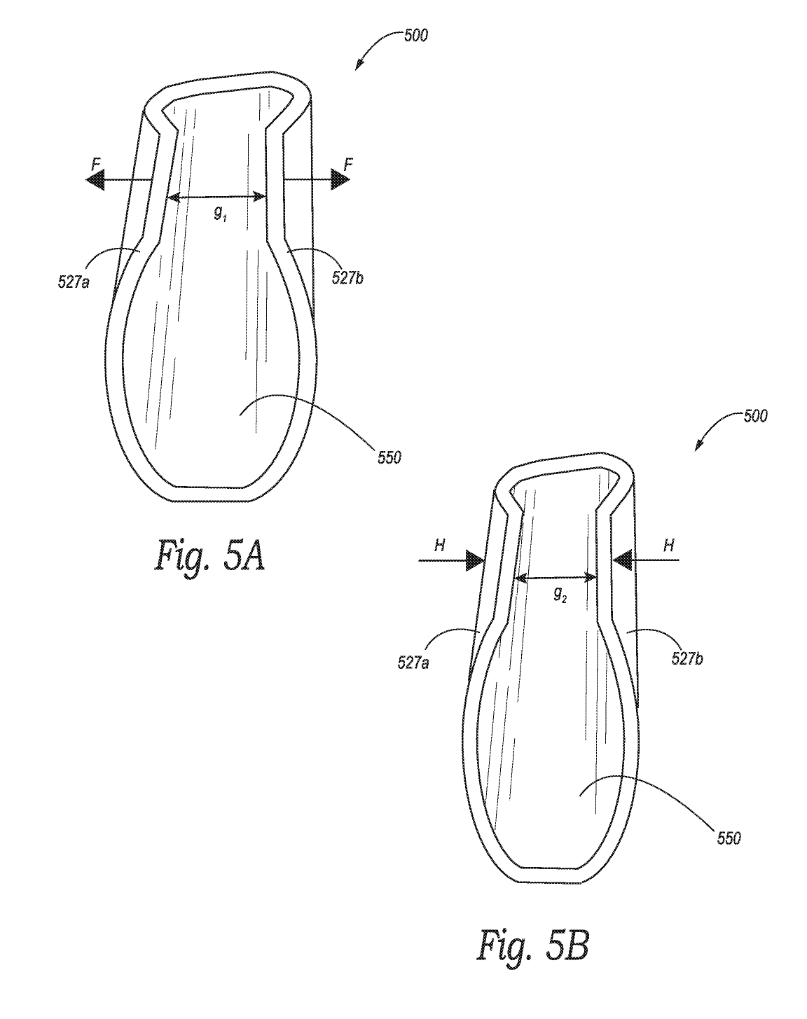

In additional or alternate embodiments, a tire tread cover can be formed from one or more materials that are molded into a desired shape. In these and other embodiments, a tread cover can be made from a memory material, such as a memory plastic, that can retain a generally fixed, yet flexible shape. Referring to FIGS. 5A and 5B, for example, in some embodiments the memory material can be configured to form a tire tread cover 500 (“tread cover 500”) having a “c”-shaped body 550 with opposing, collapsible wall portions 527a and 527b (e.g., flaps) or similar structures that can clamp onto the tire 106 (FIG. 1A). Alternately, the body can have a “u” shape having straight sidewalls and/or a non-curved base. Referring to FIG. 5A, when attaching the tread cover 500 to the tire 106, the wall portions 527 can be spread apart, as shown by arrows F. For example, the user can manually pull the wall portions 527 slightly apart from another to expand the size of a gap g₁ between the wall portions 527. Referring to FIG. 5B, when the tread cover 500 is properly positioned over the tire 106, the user can release the wall portions 527, and they can collapse onto the sidewalls 110, the wheel rim 104, and/or other portions of the tire 106 to secure the tread cover thereto by reducing the size of the gap g₁ to a smaller gap g₂, as shown by arrows H. In various embodiments, tire tread covers can be made from memory-plastic or similar materials can provide a suitable clamping force (e.g., a stick-on friction hold) that eliminates the need for the fastener 132 (FIG. 1A) and/or attachment portions that extend into the opening 107 (FIG. 1A) or around the wheel rim 104. Further, in some embodiments such “clamping” tread covers can be installed by placing the tread cover 500 on a surface (e.g., a floor surface) and rolling, pushing, or otherwise inserting the tire 106 into the opening of the cover between the wall portions 527. The tread cover 500 can be removed by the user gently pushing the cover off of the tire, such as by slightly kicking the cover off of the tire with a foot.

From the foregoing, it will be appreciated that specific embodiments of the disclosure have been described herein for purposes of illustration, but that various modifications may be made without deviating from the spirit and scope of the various embodiments of the disclosure. For example, in one embodiment each wheel of the bicycle can include a tread cover and/or the wheel can include multiple tread covers. In another embodiment, the tread cover can include various ornamental features, such as an imprinted logo, a cartoon character's head or body integrally formed or otherwise attached to the cover body (e.g., for children's bicycles), etc. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the disclosure is not limited, except as by the appended claims.

I/We claim:

1. A tread cover for use with a vehicle wheel, the wheel having a rim coupled to a hub, a tire tread carried by the rim, and an opening between the hub and the rim, the tread cover comprising:
a flexible body having a shape configured to cover a portion of the tire tread; and
an attachment portion configured to be (a) inserted into the opening of the wheel and (b) engaged with the rim within the opening to hold the flexible body against the portion of the tire tread.

2. The tread cover of claim 1 wherein:
the tire tread has a circumference;
the tire tread has an exterior surface that extends along the entire circumference; and
the flexible body is configured to cover no more than one fourth of the exterior surface extending along the circumference.

3. The tread cover of claim 2 wherein the flexible body is configured to cover no more than one eighth of the exterior surface extending along the circumference.

4. The tread cover of claim 2 wherein the flexible body is configured to cover no more than one sixteenth of the exterior surface extending along the circumference.

5. The tread cover of claim 1 wherein:
the flexible body has a first edge and a second edge opposite the first edge;
the first edge folds over a first sidewall of the tread; and
the second edge folds over a second sidewall of the tread opposite the first sidewall.

6. The tread cover of claim 5 wherein:
the attachment portion is a first attachment portion;
the first attachment portion is adjacent the first edge; and
the tread cover further comprises a second attachment portion adjacent the second edge, wherein the second attachment portion inserts into the opening of the wheel and attaches to the first attachment portion.

7. The tread cover of claim 1 wherein the flexible body is configured to at least partially conform to a shape defined by the tire tread when the attachment portion holds the flexible body against the tire tread.

8. The tread cover of claim 7 wherein the attachment portion is configured to conform to a shape defined by a portion of the rim when the attachment portion holds the flexible body against the tire tread.

9. The tread cover of claim 1 wherein the flexible body is configured to at least partially conform to a shape defined by the portion of the tire tread and a portion of the rim when the attachment portion holds the flexible body against the tire tread.

10. A tread cover assembly for use with a wheel, the wheel having a rim carrying a tire tread and coupled to a hub by a plurality of spokes, the plurality of spokes including a first spoke and a second spoke adjacent the first spoke, wherein the tread cover assembly comprises:
a flexible cover including a body portion and an attachment portion extending from the body portion, wherein the body portion is configured to cover a portion of the tire tread, and the attachment portion is configured to be inserted between the first and second spokes; and
an attachment feature configured to releasably engage the attachment and body portions when (a) the body portion is positioned over the portion of the tread and (b) the attachment portion is inserted between the first and second spokes.

11. The tread cover assembly of claim 10 wherein the flexible cover comprises a sheet of flexible material.

12. The tread cover assembly of claim 10 wherein the flexible cover comprises leather.

13. The tread cover assembly of claim 10 wherein the flexible cover comprises molded plastic.

14. The tread cover assembly of claim 10 wherein the body portion includes:
a base region configured to cover an exterior surface of the tire tread; and
a flap region extending from the base region and configured to cover a sidewall of the tire tread.

15. The tread cover assembly of claim 15 wherein the base region has a generally rectangular shape, and the flap region has a generally triangular shape.

16. The tread cover assembly of claim 10 wherein:
the attachment portion is a first attachment portion; and
the flexible cover further includes a second attachment portion extending from the body portion.

17. The tread cover assembly of claim 16 wherein the second attachment portion is configured to insert between the first and second spokes.

18. The tread cover assembly of claim 16 wherein:
the plurality of spokes includes a third spoke adjacent the second spoke; and
the second attachment portion is configured to insert between the second and third spokes.

19. The tread cover assembly of claim 16 wherein:
the plurality of spokes includes third and fourth spokes separated from the first and second spokes along the rim by at least one intermediary spoke; and
the second attachment portion is configured to insert between the third and fourth spokes.

20. A bicycle wheel assembly, comprising:
a wheel having a hub, a plurality of spokes extending radially outward from the hub, a rim attached to the spokes, and a tire tread carried by the rim; and
a tread cover including a body portion configured to engage a portion of the tire tread.

21. The bicycle wheel assembly of claim 20 wherein the body portion is a flat body portion, and wherein the tread cover further includes:
an attachment portion extending from the body portion and configured to be inserted between individual spokes of the plurality spokes, and
one or more attachment features configured to releasably engage the attachment portion with the body portion.

22. The bicycle wheel assembly of claim 21 wherein the one or more attachment features includes a button snap.

23. The bicycle wheel assembly of claim 21 wherein the one or more attachment features includes a magnetic feature.

24. The bicycle wheel assembly of claim 20 wherein the body portion includes opposing walls configured to clamp the body portion onto at least one of the tire tread and the hub.

25. The bicycle wheel assembly of claim 20 wherein the body portion is formed from a memory material.

26. The bicycle wheel assembly of claim 20 wherein the body portion has a “c” shape or a “u” shape.

27. The bicycle wheel assembly of claim 20 wherein the body portion includes opposing walls configured to clamp the body portion onto at least one of the tire tread and the hub without an attachment portion and without a fastener.
